(19) United States
(12) Patent Application Publication
(10) Pub. No.: US 2024/0241992 A1
(43) Pub. Date: Jul. 18, 2024

(54) REGISTRATION APPLICATION SUPPORT SYSTEM AND REGISTRATION APPLICATION SUPPORT METHOD

(71) Applicant: NIPPON TELEGRAPH AND TELEPHONE CORPORATION, Tokyo (JP)

(72) Inventors: Ryohei SUZUKI, Tokyo (JP); Koji CHIDA, Tokyo (JP); Tetsuya OKUDA, Tokyo (JP)

(21) Appl. No.: 18/561,957

(22) PCT Filed: Jun. 7, 2021
(86) PCT No.: PCT/JP2021/021571

§ 371 Date: Nov. 17, 2023

(51) Int. Cl. G06F 21/64; G06F 21/10

(52) U.S. Cl. CPC G06F 21/64; G06F 21/101

(57) ABSTRACT

A registration application support system includes: a registration application device that is included in a first organization and applies for pre-registration for delegation of a right regarding access to a resource to an authorization server; and an existence guarantee device that is included in a second organization and guarantees existence of the first organization, in which: the existence guarantee device includes a giving unit that gives an electronic signature to information that guarantees the existence of the first organization, in response to a request from a terminal used by a member of the first organization; the registration application device includes a transmission unit that transmits a display name of the first organization and the information to which the electronic signature has been given to the authorization server in order to apply for the pre-registration; and the authorization server includes a verification unit that causes the existence guarantee device to verify the electronic signature, and a determination unit that determines whether or not the first organization has a right to use the display name. Therefore, pre-registration for delegation of an access right to a resource is safely and efficiently performed.

### TECHNICAL FIELD

The present invention relates to a registration application support system and a registration application support method.

### BACKGROUND ART

OAuth is known as a technical specification for delegation of some rights to others (Non Patent Literature 1 and Non Patent Literature 2). OAuth is used to allow a right person to use a Web API.

Players (characters) regarding OAuth are a resource owner (RO), a resource server (RS), a relying party (RP), and an authorization server (AS). The RO is an owner of a resource such as data and is a user who uses the resource via a certain service provided by a third party. The RS manages the resource of the RO (management entities of the AS and the RS are generally the same). The RP is the third party that provides the certain service. When providing the service, a right is delegated to the RP from the RO, and the RP accesses the resource managed by the RS on behalf of the RO. The AS delegates an access right of the resource to the RP.

Specifically, first, the RO uses the service of the RP. At that time, the RO selects interaction between the AS and the RP (the RO selects interaction between the RP and the AS while accessing to the RP). The RO is redirected from the RP to the AS and authorizes interaction with the RP (agrees to delegate a right) on the AS. As a result, the RP can obtain an access token necessary for accessing the resource managed by the RS.

OAuth needs to be prepared before use. Specifically, when the RP interacts with the AS, it is necessary to register the RP itself in the AS. The registration of the RP itself means registration of an account of a developer of the service in the RP. At the time of registration, the AS verifies application from the RP and examines whether to allow registration. For the application, information such as interaction destination information (information regarding the RP), a display name, a contact address, and a right that the user desires to delegate=scope is required.

### CITATION LIST

### Non Patent Literature

Non Patent Literature 1: The OAuth 2.0 Authorization Framework (RFC6749), [online], Internet <URL:https://tools.ietf.org/html/rfc6749>
Non Patent Literature 2: The OAuth 2.0 Authorization Framework: Bearer Token Usage (RFC6750), [online], Internet <URL:https://tools.ietf.org/html/rfc6750>

### SUMMARY OF INVENTION

### Technical Problem

However, the above-described preparation is manually performed and is thus costly, and the display name of the RP may be falsely registered.

The present invention has been made in view of the above points, and an object thereof is to safely and efficiently perform pre-registration for delegation of an access right to a resource.

### Solution to Problem

Therefore, in order to solve the above problem, a registration application support system includes: a registration application device that is included in a first organization and applies for pre-registration for delegation of a right regarding access to a resource to an authorization server; and an existence guarantee device that is included in a second organization and guarantees existence of the first organization, in which: the existence guarantee device includes a giving unit that gives an electronic signature to information that guarantees the existence of the first organization, in response to a request from a terminal used by a member of the first organization; the registration application device includes a transmission unit that transmits a display name of the first organization and the information to which the electronic signature has been given to the authorization server in order to apply for the pre-registration; and the authorization server includes a verification unit that causes the existence guarantee device to verify the electronic signature, and a determination unit that determines whether or not the first organization has a right to use the display name.

### Advantageous Effects of Invention

It is possible to safely and efficiently perform pre-registration for delegation of an access right to a resource.

### BRIEF DESCRIPTION OF DRAWINGS

FIG. 1 illustrates a configuration example of a registration application support system according to an embodiment of the present invention.

FIG. 2 illustrates a hardware configuration example of an existence guarantee device 10 according to an embodiment of the present invention.

FIG. 3 illustrates a functional configuration example of a registration application support system according to an embodiment of the present invention.

FIG. 4 is a sequence diagram showing an example of a processing procedure executed in a registration application support system.

FIG. 5 is a flowchart showing an example of a processing procedure of processing of preparing existence guarantee information.

FIG. 6 is a flowchart showing an example of a processing procedure of processing of preparing existence guarantee information.

FIG. 7 is a sequence diagram showing an example of a processing procedure of processing of verifying existence guarantee information.

FIG. 8 is a sequence diagram showing an example of a processing procedure of processing of confirming whether or not an RP can use a display name.

### DESCRIPTION OF EMBODIMENTS

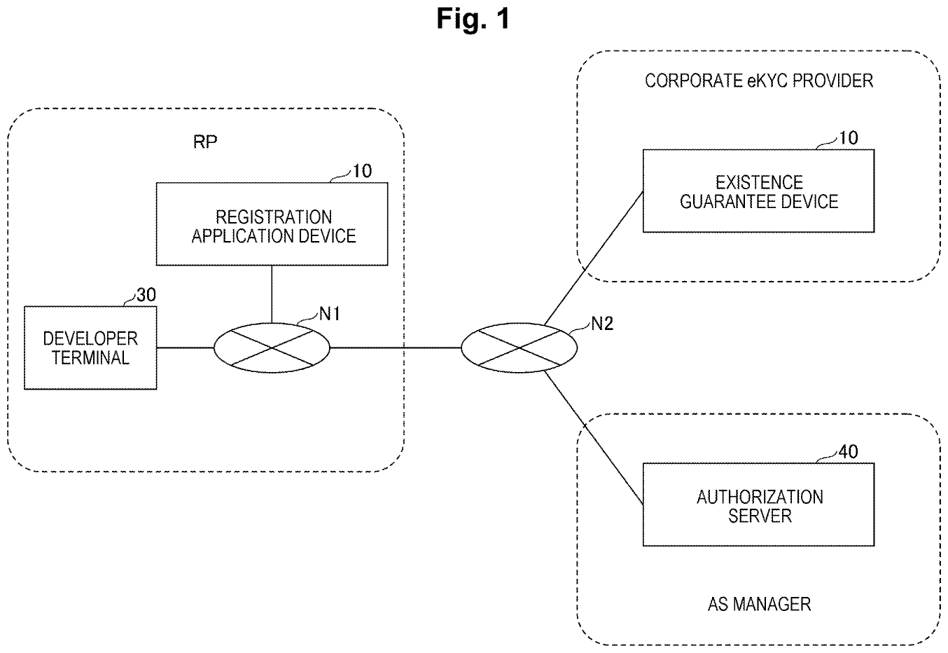

Hereinafter, an embodiment of the present invention will be described with reference to the drawings. FIG. 1 illustrates a configuration example of a registration application support system according to an embodiment of the present invention. In FIG. 1, each region surrounded by a broken line indicates an organization. In the present embodiment, computers of two organizations, i.e., an RP and a corporate ekYC provider interact with an authorization server 40 via a network N2 such as the Internet.

The RP is a relying party that is one of players regarding OAuth. In the present embodiment, the RP applies for registration of the RP itself in the authorization server 40, which is required as a preparation for using OAuth (for delegation of an access right to a resource). The registration application of the RP itself is an application for registration of an account of a member of the RP who is a developer of a service in the RP. In FIG. 1, the RP includes a registration application device 20 and one or more developer terminals 30.

The developer terminal 30 is a terminal such as a personal computer (PC) used by the developer who applies for registration (i.e. the developer who registers an account) of the RP (hereinafter, simply referred to as “registration application”). The developer terminal 30 is connected to the registration application device 20 via a network N1 in the RP.

### [AAAA]

The registration application device 20 is one or more computers that cause the corporate ekYC provider to guarantee existence of a corporation as the RP, guarantee existence of the developer with respect to the corporate ekYC provider, and then perform registration application on the AS. Note that the existence of the developer means that the developer certainly belongs to the corporation. The registration application device 20 is connected to the existence guarantee device 10 and the authorization server 40 via the network N1 and the network N2.

The corporate ekYC provider is an organization that is assumed to exist in the present embodiment and is an organization that guarantees the existence of the corporation (insistence of the corporation). The corporate ekYC provider has a function as a general PKI authentication infrastructure (hereinafter, referred to as “corporate PKI”), and the corporate PKI allows the corporation to use an electronic signature. The corporate ekYC provider may be implemented by a government or a third party organization. That is, the government or the like may electronically guarantee the existence of the corporation, or the third party organization may provide information that identifies the corporation. The identity of the corporation can be guaranteed in any case, and thus a guarantor of the identity (existence or identification) of the corporation may be either the government or the third party.

In FIG. 1, the corporate ekYC provider includes an existence guarantee device 10. The existence guarantee device 10 is one or more computers that electronically implement a function of the corporate ekYC provider. For example, the existence guarantee device 10 guarantees the existence of the corporation or confirms the existence of the developer (belongingness of the developer to the corporation).

The authorization server 40 is one or more computers that function as an AS that is one of the players regarding OAuth. In the present embodiment, the authorization server 40 performs processing for electronically registering the RP in response to the registration application.

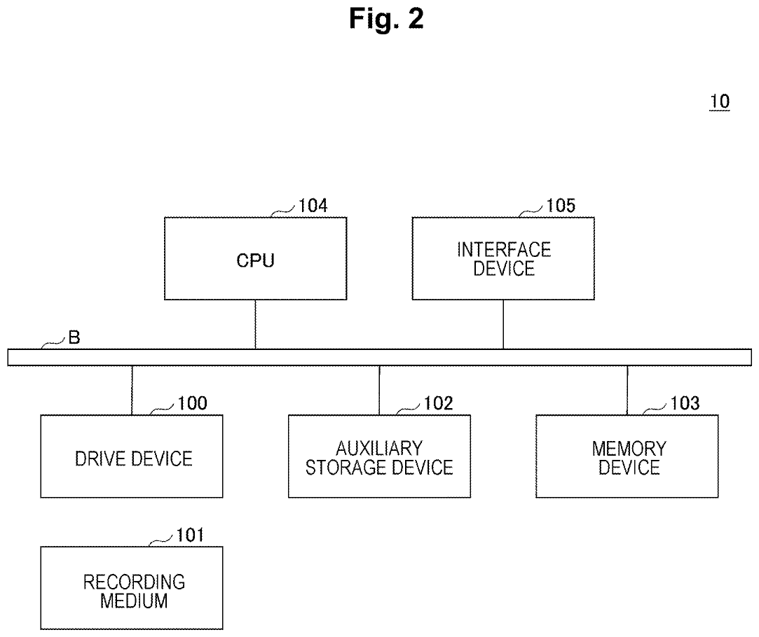

FIG. 2 illustrates a hardware configuration example of the existence guarantee device 10 according to the embodiment of the present invention. The existence guarantee device 10 in FIG. 2 includes, for example, a drive device 100, an auxiliary storage device 102, a memory device 103, a CPU 104, and an interface device 105, which are connected to each other by a bus B.

A program for implementing processing in the existence guarantee device 10 is provided by a recording medium 101 such as a CD-ROM. When the recording medium 101 storing the program is set in the drive device 100, the program is installed to the auxiliary storage device 102 from the recording medium 101 via the drive device 100. However, the program is not necessarily installed from the recording medium 101 and may be downloaded from another computer via a network. The auxiliary storage device 102 stores the installed program and also stores necessary files, data, and the like.

In a case where an instruction to start the program is issued, the memory device 103 reads the program from the auxiliary storage device 102 and stores the program. The CPU 104 executes a function regarding the existence guarantee device 10 according to the program stored in the memory device 103. The interface device 105 is used as an interface for connection to a network.

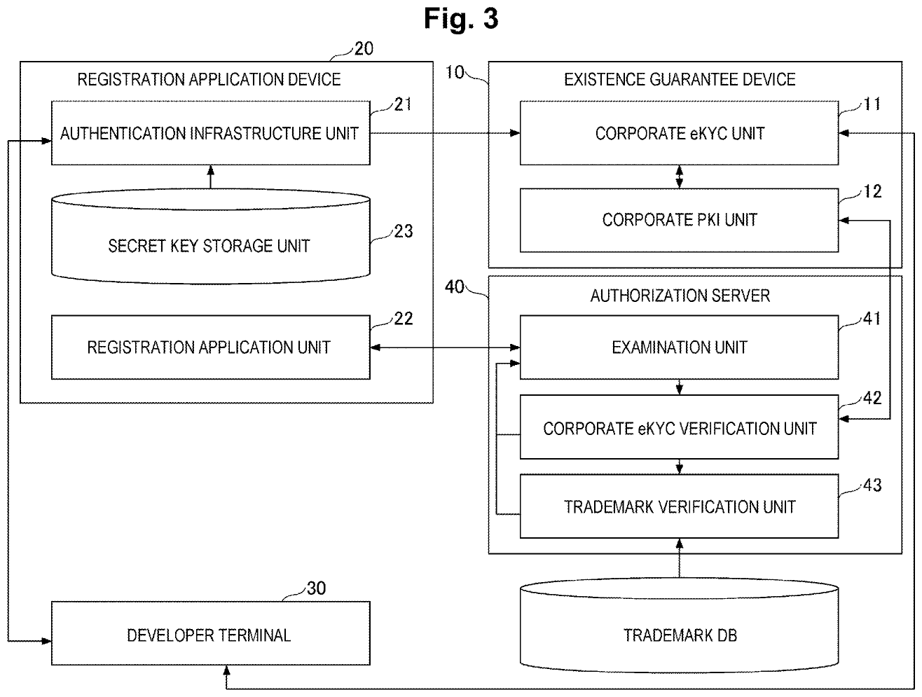

FIG. 3 illustrates a functional configuration example of the registration application support system according to the embodiment of the present invention. In FIG. 3, the registration application device 20 includes an authentication infrastructure unit 21 and a registration application unit 22. Those units are implemented by processing that one or more programs installed in the registration application device 20 cause a CPU of the registration application device 20 to execute. The registration application device 20 also uses a secret key storage unit 23. The secret key storage unit 23 can be implemented by using, for example, an auxiliary storage device of the registration application device 20 or a storage device connectable to the registration application device 20 via a network.

The authentication infrastructure unit 21 authenticates the developer and confirms whether or not the developer has a right to request information that guarantees the existence of the corporation (hereinafter, referred to as “existence guarantee information”) from the corporate eKYC provider (hereinafter, simply referred to as “right”).

The secret key storage unit 23 stores a secret key (hereinafter, referred to as “corporate secret key”) used to give a signature verifiable by a corporate PKI unit 12 of the existence guarantee device 10. The corporate secret key is provided from the corporate PKI unit 12.

The registration application unit 22 transmits a registration application to the authorization server 40. The registration application unit 22 can also confirm “existence of an applying organization” and “belongingness of an applicant to the organization”.

The existence guarantee device 10 includes a corporate eKYC unit 11 and the corporate PKI unit 12. Those units are implemented by processing that one or more programs installed in the existence guarantee device 10 cause the CPU 104 to execute. However, those units may be implemented by different computers.

The corporate ekYC unit 11 provides the RP with information (existence guarantee information) that guarantees the existence of the corporation. The corporate eKYC unit 11 causes the corporate PKI unit 12 to give an electronic signature by the corporate ekYC provider to the information that guarantees the existence of the corporation.

The corporate PKI unit 12 provides a general PKI for the RP. For example, the corporate PKI unit 12 distributes a public key certificate or a root certificate of the corporate ekYC provider to the RP.

The authorization server 40 includes an examination unit 41, a corporate ekYC verification unit 42, and a trademark verification unit 43. Those units are implemented by processing that one or more programs installed in the authorization server 40 cause a CPU of the authorization server 40 to execute.

The examination unit 41 performs examination processing not specified in the present embodiment for the registration application. The examination unit 41 performs registration processing according to the registration application on the basis of a verification result by the corporate ekYC verification unit 42 and the trademark verification unit 43.

The corporate ekYC verification unit 42 verifies the existence guarantee information added to (included in) the registration application.

The trademark verification unit 43 refers to a trademark DB to determine whether or not the PR that has issued an application request has a right (e.g. trademark right) to legitimately use a display name (i.e. trademark) included in the application request.

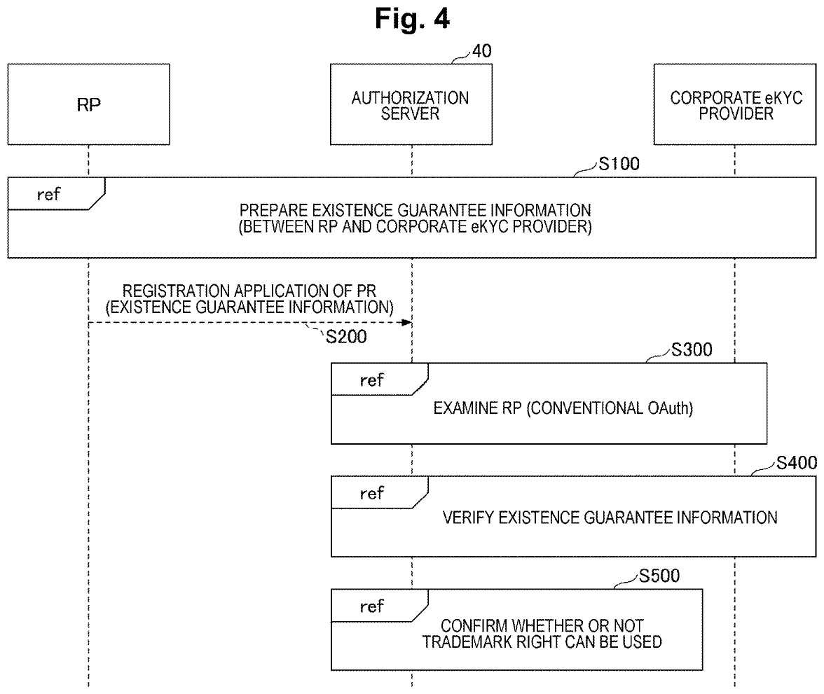

Hereinafter, a processing procedure executed in the registration application support system will be described. FIG. 4 is a sequence diagram showing an example of the processing procedure executed in the registration application support system.

In step S100, processing of preparing existence guarantee information is executed between the RP and the corporate ekYC provider.

Then, the registration application unit 22 of the RP transmits a registration application request to the authorization server 40 (S200). The registration application includes not only information conventionally required for the registration application but also existence guarantee information (existence guarantee information of the corporation and existence guarantee information of the developer) generated in the processing of preparing existence guarantee information. The information conventionally required for the registration application includes, for example, information such as interaction destination information (information regarding the RP serving as an application source), a display name, a contact address, and a right that the user desires to delegate=scope.

Then, the examination unit 41 of the authorization server 40 executes examination processing of the RP as necessary (S300). The examination processing may have arbitrary content.

Then, processing of verifying the existence guarantee information is executed between the authorization server 40 and the corporate ekYC provider (S400).

Then, the trademark verification unit 43 of the authorization server 40 executes processing of confirming whether or not the RP can use the display name of the RP included in the registration application (S500).

When it is confirmed in step S400 that the existence guarantee information is valid and it is confirmed in step S500 that the RP can use the display name, the examination unit 41 performs registration according to the registration application. Otherwise, the examination unit 41 does not perform registration according to the registration application. The registered information (regarding RP) is used to confirm whether or not the RP that is requested by the AS (authorization server 40) to perform OAuth interaction is authentic and also to present correct information (e.g. display name) to the RO at the time of authorization.

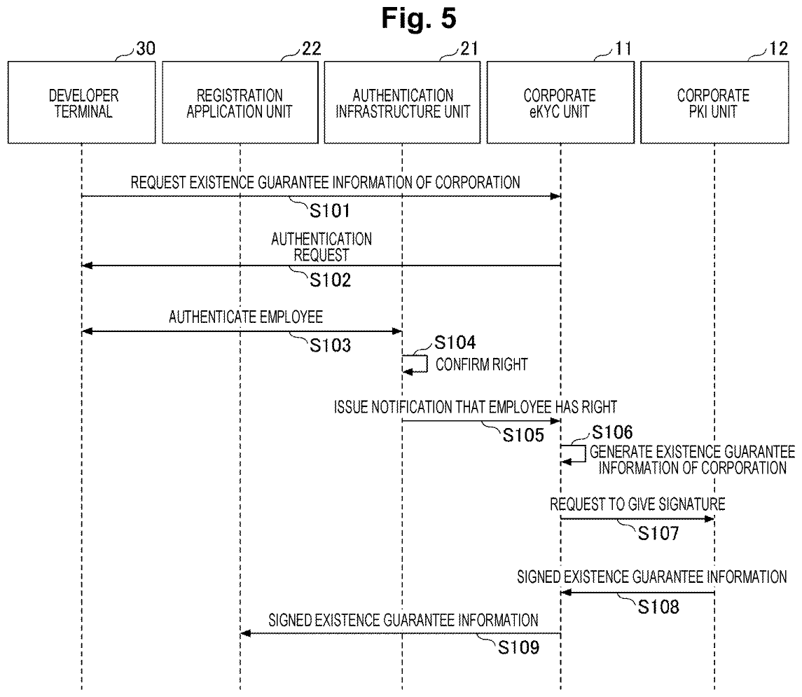

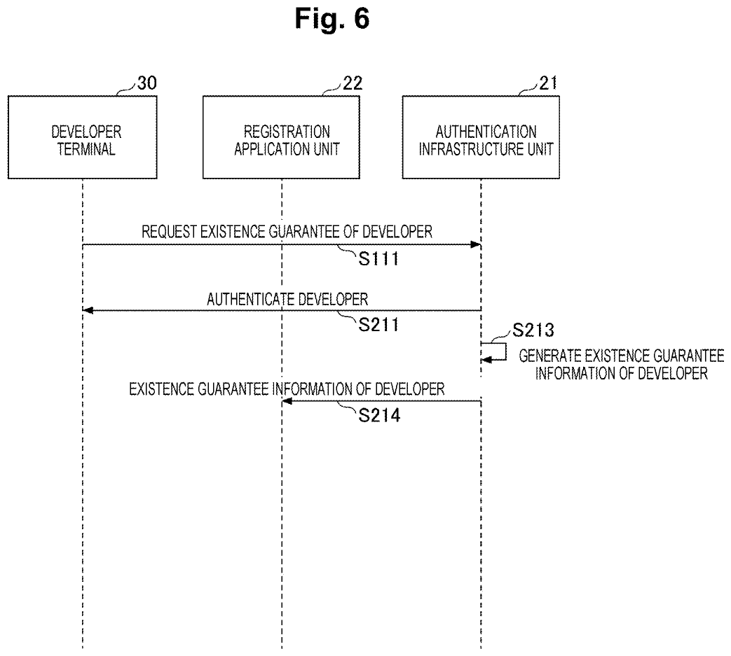

Next, details of step S100 will be described. FIGS. 5 and 6 are flowcharts showing an example of a processing procedure of the processing of preparing existence guarantee information.

In step S101, the developer terminal 30 requests the existence guarantee information of the corporation from the corporate eKYC unit 11 in response to an input by the developer (instruction to acquire the existence guarantee information of the corporation). In response to the request from the developer terminal 30, the corporate eKYC unit 11 transmits an authentication request to the developer terminal 30 (S102). Note that the reason why the authentication request is transmitted from the corporate eKYC unit 11 to the developer terminal 30 is that the authentication infrastructure unit 21 capable of authenticating the developer is in the corporation (in the registration application device 20) serving as the RP, and the existence guarantee device 10 cannot authenticate the developer. Therefore, the corporate eKYC unit 11 transmits the authentication request to the developer terminal 30 so that the authentication request is redirected to the authentication infrastructure unit 21.

In response to the authentication request, the developer terminal 30 authenticates the developer in cooperation with the authentication infrastructure unit 21 of the registration application device 20 (S103). For example, the developer terminal 30 displays a screen for inputting an ID and password of the developer for the authentication. The developer terminal 30 transmits the ID and password input to the screen to the authentication infrastructure unit 21. The authentication infrastructure unit 21 compares the ID and the password with a correct ID and password stored in advance in the registration application device 20 and succeeds in authenticating the developer when the IDs and the passwords match. Note that the authentication is performed to acquire the existence guarantee information of the corporation (i.e. to use the corporate eKYC unit 11).

When succeeding in authenticating the developer, the authentication infrastructure unit 21 confirms whether or not the developer has a right to “request the existence guarantee information of the corporation from the corporate eKYC unit 11” (S104). For example, the registration application device 20 stores information indicating whether or not each member of the corporation has the right, and the authentication infrastructure unit 21 refers to the information to confirm whether or not the developer has the right.

When the developer has the right, the authentication infrastructure unit 21 notifies the corporate eKYC unit 11 that the developer has the right (S105). Note that the notification may be executed in any procedure. For example, the corporate eKYC unit 11 may transmit a token that is data indicating that the developer has the right to the developer terminal 30, and the developer terminal 30 may transmit the token to the corporate eKYC unit 11. In this case, when the corporate eKYC unit 11 inquires of the authentication infrastructure unit 21 whether or not the developer has the right along with the token, the authentication infrastructure unit 21 may verify the token and return a notification that the developer has the right to the corporate eKYC unit 11 when the token is valid.

In response to the notification that the developer has the right, the corporate eKYC unit 11 generates the existence guarantee information of the corporation (S106). For example, the corporate eKYC unit 11 generates the following existence guarantee information in the JavaScript (registered trademark) Object Notation (JSON) format. {“iss”:“https://ekyc.example.com”, “aud”: “xxxx”, “name”: “xxxx Corp”, . . . }

In the above existence guarantee information, “xxxx” denotes a character string indicating a name of the corporation, for example.

Then, the corporate ekYC unit 11 transmits the existence guarantee information to the corporate PKI unit 12 and requests the corporate PKI unit 12 to give a signature (electronic signature) to the existence guarantee information (S107). The corporate PKI unit 12 signs the existence guarantee information (gives a signature to the existence guarantee information) with a secret key of the corporate ekYC provider by using the corporation PKI and returns the signed existence guarantee information to the corporate eKYC unit 11 (S108). With the signature, the authorization server 40 can confirm authenticity of the existence guarantee information.

Then, the corporate eKYC unit 11 transmits the signed existence guarantee information to the registration application unit 22 of the registration application device 20 (S109). However, the existence guarantee information may be transmitted to the registration application unit 22 via the developer terminal 30. In this case, the corporate eKYC unit 11 transmits the existence guarantee information to the developer terminal 30 as a response to step S101. The developer terminal 30 transmits the existence guarantee information to the registration application unit 22. The registration application unit 22 holds the existence guarantee information in order to transmit the existence guarantee information in step S200 of FIG. 4.

Thereafter, the developer terminal 30 requests the authentication infrastructure unit 21 to guarantee the existence of the developer in response to an input by the developer (instruction to request guarantee of the existence of the developer) at an arbitrary timing (FIG. 6: S111). The authentication infrastructure unit 21 cooperates with the developer terminal 30 to authenticate the developer (S211). By the authentication, whether or not the developer is the person himself/herself is confirmed.

When succeeding in authenticating the developer, the authentication infrastructure unit 21 generates existence guarantee information of the developer (S213). For example, the authentication infrastructure unit 21 generates the following existence guarantee information in the JSON format.
{“affiliation”:“xxx Corp.”, “name”:“yyy”, . . . }

In the above existence guarantee information, for example, “xxx” denotes a character string indicating the name of the corporation, and “yyy” denotes a character string indicating a name of the developer.

Note that the authentication infrastructure unit 21 signs (gives a signature to) the generated existence guarantee information by using a corporate secret key. By giving a signature to the existence guarantee information by using the corporate secret key, the existence (belongingness) of the developer is guaranteed by the corporation. The corporate ekYC verification unit 42 can confirm the authenticity of the existence guarantee information on the basis of the signature. The signature may be performed by an external service. For example, a management function or a signature function of the corporate secret key may be performed by an external service.

Then, the authentication infrastructure unit 21 transmits the signed existence guarantee information to the registration application unit 22 (S214). However, the existence guarantee information may be transmitted to the registration application unit 22 via the developer terminal 30. In this case, the authentication infrastructure unit 21 transmits the existence guarantee information to the developer terminal 30 as a response to step S111. The developer terminal 30 transmits the existence guarantee information to the registration application unit 22. The registration application unit 22 holds the existence guarantee information in order to transmit the existence guarantee information in step S200 of FIG. 4.

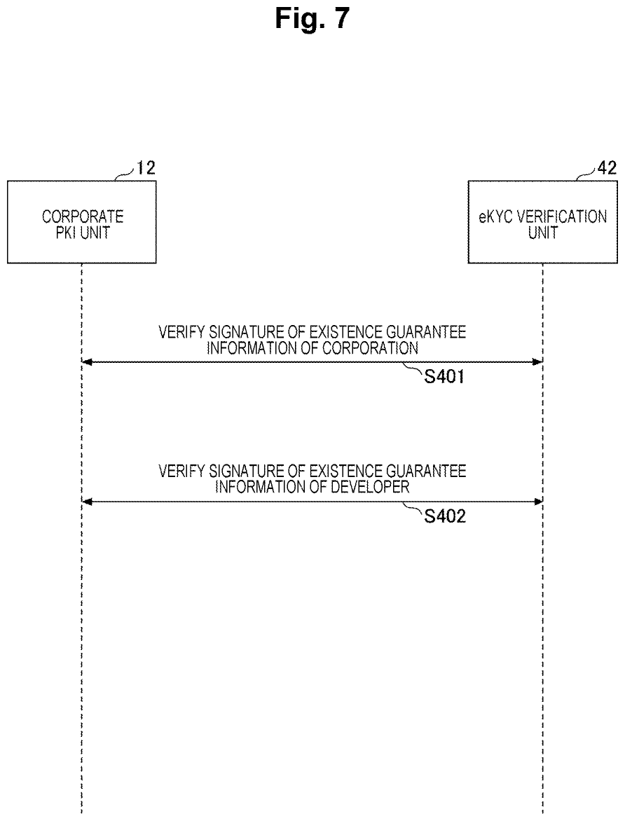

Next, details of step S400 in FIG. 4 will be described. FIG. 7 is a sequence diagram showing an example of a processing procedure of the processing of verifying the existence guarantee information.

In step S401, the corporate ekYC verification unit 42 causes the corporate PKI unit 12 to verify the signature given to the existence guarantee information of the corporation included in the registration application in step S200. When the corporate PKI unit 12 confirms that the signature is authentic, the corporate ekYC verification unit 42 records the existence guarantee information as information indicating completion of the confirmation that the corporation exists.

Then, the corporate ekYC verification unit 42 cooperates with the corporate PKI unit 12 to verify the signature given to the existence guarantee information of the developer included in the registration application in step S200 (S402). In other words, the corporate PKI unit 12 cooperates with the corporate ekYC verification unit 42 to verify the signature given to the existence guarantee information. For example, the corporate ekYC verification unit 42 receives a corporate public key from the corporate PKI unit 12 and verifies the signature. However, the distribution of the corporate public key may be performed by another method (at another timing). Alternatively, the corporate PKI unit 12 may verify the signature given to the existence guarantee information and transmit a result thereof to the corporate ekYC verification unit 42. When it is confirmed that the signature is authentic, the corporate ekYC verification unit 42 records the existence guarantee information as information indicating completion of the confirmation that the developer belongs to the corporation serving as the PR.

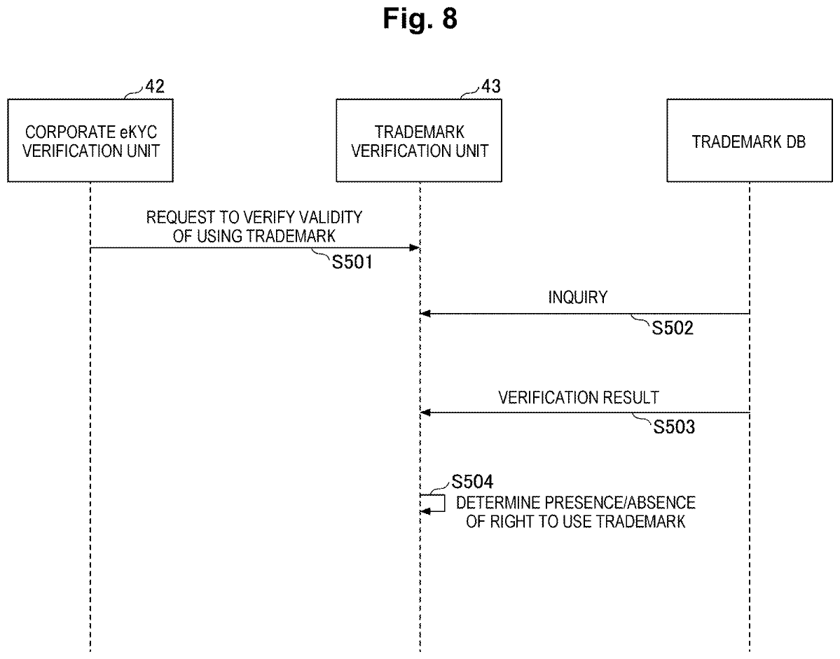

Next, details of step S500 in FIG. 4 will be described. FIG. 8 is a sequence diagram showing an example of a processing procedure of the processing of confirming whether or not the RP can use the display name.

In step S501, the corporate ekYC verification unit 42 transmits, to the trademark verification unit 43, a request to verify validity of using the display name (i.e. trademark) included in the registration application. The verification request includes the display name included in the registration application.

In response to the verification request, the trademark verification unit 43 refers to, for example, the trademark DB to determine whether or not an applicant of the name included in the verification request has a right (e.g. trademark right) to legitimately use the display name (i.e. trademark) included in the verification request (S502 to S504). For example, the trademark verification unit 43 may search the trademark DB for the trademark on the basis of the display name and determine whether or not the applicant has the right on the basis of the search result. The trademark DB may be, for example, a database of the Patent Office that is open to the public. Alternatively, an organization that operates the authorization server 40 may create the trademark DB in advance.

Alternatively, the verification request may include search conditions of the name of the applicant and the display name (i.e. trademark) to be verified. That is, the verification request does not necessarily include the display name itself and may include information capable of specifying the display name (i.e. trademark).

The above determination result is a verification result of the verification request.

As described above, according to the present embodiment, existence of the RP that applies for registration in the AS is electronically confirmed and is then registered. The validity of the display name (service name) regarding the application is also electronically confirmed. Therefore, pre-registration for delegation of an access right to a resource can be safely and efficiently performed.

In the present embodiment, the RP is an example of a first organization. The corporate ekYC provider is an example of a second organization. The corporate PKI unit 12 is an example of a giving unit. The registration application unit 22 is an example of a transmission unit. The corporate ekYC verification unit 42 is an example of a verification unit. The trademark verification unit 43 is an example of a determination unit.

Although the embodiment of the present invention has been described in detail above, the present invention is not limited to such a specific embodiment, and various modifications and changes can be made within the scope of the gist of the present invention described in the claims.

### REFERENCE SIGNS LIST

1. A registration application support system comprising: a registration application device that is included in a first organization and applies for pre-registration for delegation of a right regarding access to a resource to an authorization server; and an existence guarantee device that is included in a second organization and guarantees existence of the first organization, wherein:
the existence guarantee device includes a memory; and a processor coupled to the memory and configured to:
give an electronic signature to information that guarantees the existence of the first organization, in response to a request from a terminal used by a member of the first organization;
the registration application device includes a memory; and a processor coupled to the memory and configured to:
transmit a display name of the first organization and the information to which the electronic signature has been given to the authorization server in order to apply for the pre-registration; and
the authorization server includes a memory; and a processor coupled to the memory and configured to:
cause the existence guarantee device to verify the electronic signature, and
determine whether or not the first organization has a right to use the display name.

2. The registration application support system according to claim 1, wherein
the processor of the existence guarantee device gives the electronic signature to the information in a case where the member is authenticated.

3. The registration application support system according to claim 1, wherein
the processor of the authorization server determines whether or not the first organization has a trademark right regarding the display name.

4. A registration application support method comprising: a registration application device that is included in a first organization and applies for pre-registration for delegation of a right regarding access to a resource to an authorization server; and an existence guarantee device that is included in a second organization and guarantees existence of the first organization, wherein:
the existence guarantee device executes
giving an electronic signature to information that guarantees the existence of the first organization, in response to a request from a terminal used by a member of the first organization;
the registration application device executes
transmitting a display name of the first organization and the information to which the electronic signature has been given to the authorization server in order to apply for the pre-registration; and
the authorization server executes
causing the existence guarantee device to verify the electronic signature, and
determining whether or not the first organization has a right to use the display name.

5. The registration application support method according to claim 4, wherein
in the giving of the electronic signature, the electronic signature is given to the information in a case where the member is authenticated.

6. The registration application support method according to claim 4, wherein
whether or not the first organization has a trademark right regarding the display name is determined in the determining.
